(19) United States
(12) Patent Application Publication
(10) Pub. No.: US 2016/0198223 A1
(43) Pub. Date: Jul. 7, 2016

(54) A METHOD AND SYSTEM FOR PROVIDING AND MANAGING A SOCIAL PLATFORM THAT VISUALIZES VIRTUAL CROWD

(71) Applicant: LIVINGRID LTD., Tel Aviv (IL)

(72) Inventors: Yaacov MALUK, Tel Mond (IL); Tomer BEN SHALOM, Tel Aviv (IL); Zemer AVITAL, Tel Aviv (IL); Arbel RAZ, Ramat Gan (IL)

(21) Appl. No.: 14/655,762

(22) PCT Filed: Dec. 25, 2013
(86) PCT No.: PCT/IL2013/051065

§ 371 Date: Jun. 26, 2015

Related U.S. Application Data
(60) Provisional application No. 61/745,908, filed on Dec. 26, 2012.

(51) Int. Cl. H04N 21/442; H04N 21/4788; H04N 21/25; H04L 12/18; H04L 12/58

(52) U.S. Cl. CPC H04N 21/44218; H04L 12/1827; H04L 51/32; H04N 21/252; H04N 21/4788; G06Q 50/01

(57) ABSTRACT

A method and a system for visualizing and managing virtual audience over a data communication network, wherein virtual audience reflects and represents real human individuals while they are consuming and interacting with each other and/or with the same digital content item at the same time. The method comprising the steps of:
1. real time tracking and analysis of the user interactions
2. determining dynamic crowd's reaction scale, based on users analyzed interaction
3. measuring and/or calculating in real time the crowd's reactions level
4. determining or updating visual customized grouping of the crowd for each user, such as at least a partial group of users is selected and grouped from the plurality of users, based on predefined grouping rules and the user's requests and preferences
5. determining, updating and presenting, in real time, the crowd presentation and the content page, according to the viewers' reactions and the crowd's reaction level.

### BACKGROUND

### Technical Field

The present invention relates to the field of social platform over the IP network, which visualizes and manages virtual audience, which reflects real human individuals while they are consuming, interacting and optionally affecting digital content with a substantial focus on video content.

### BRIEF SUMMARY

The present invention provides a method and system of visualizing and managing virtual audience over a data communication network, wherein virtual audience reflects and represents real human individuals while they are consuming and interacting with each other and/or with the same digital content item at the same time. The method comprising the steps of: tracking and analyzing in real time user interactions and behavior in relation to the consumed content item, determining dynamic crowd's reaction parameters and scale based on users analyzed interaction and identified behavior, measuring and/or calculating in real time at least partial group of the crowd's reactions level according to the determined crowd's reaction measurement parameters and scale, determining or updating visual customized grouping of the crowd for specific user, such as for each user, at least a partial group of users is selected and grouped from the plurality of users based on predefined grouping rules and determining and/or updating in real time the crowd presentation which includes: (1) the specific virtual crowd identities (avatars) of the customized groups which represent specific viewers, (2) position and layout of the avatars and (3) graphical effects reflecting crowd personal and/or partial group reactions, according to viewers' individuals reactions and/or to the measured crowd's reaction level.

According to some embodiments of the present invention the personalized visualization of the crowd for each viewer is based on the determined crowd presentation, and the determined visual customized grouping.

According to some embodiments of the present invention the method further comprising the steps of:
receiving real time event data which includes data that is (1) received in real time, (2) related to the consumed content and (3) occurred during the time the content is consumed;
checking received real time event data against predefined content item format rules; wherein the real time process of determining the crowd presentation is further based on the received real time event data in relations to the predefined content rules;

According to some embodiments of the present invention the method further comprising the steps of:
receiving user's preferences and/or requests in relation to the customized grouping of virtual audience;
   wherein the process of determining or updating visual grouping of customized crowd for specific user is further based on the user's requests and preferences.

According to some embodiments of the present invention the crowd presentation is further based on the viewer's explicit requests and preferences which relates to the customized grouping of virtual audience.

According to some embodiments of the present invention the content item is a scheduled content event which takes place on specific time period and the received real time event data relates to specific scenarios which occur during and relate to the scheduled content event.

According to some embodiments of the present invention the method further comprising the step of
displaying in real time visualization or representation of crowd's measures and/or calculated reaction level, in relation to the crowd's reaction measurements parameters and scale.

According to some embodiments of the present invention the method further comprising the step of
analyzing in real time user interactions and identifying user behavior patterns based on user's interaction analysis.

According to some embodiments of the present invention further comprising the steps of
including format rules of the content items, which relate to viewers' individuals reactions and/or to the measured crowd's reaction level
applying changes in content presentation and/or in the content event scenario, according to viewers' individuals reactions and/or to the measured crowd's reaction level, in relation to the format rules.

According to some embodiments, the present invention provides a system of visualizing and managing virtual audience over a data communication network, wherein virtual audience reflects and represents real human individuals while they are consuming and interacting with each other and/or with the same digital content item at the same time. The system comprised of:
a Crowd's Reaction Detection Module for tracking and analyzing in real time user interactions and behavior in relation to the consumed content item and identifying user behavior pattern based on user's interaction analysis
a Crowd's Reaction Measurement Module for (1) determining crowd's reaction measurement parameters and scale, based on users analyzed interaction and identified behavior, and (2) measuring in real time the reaction level of the overall crowd and/or partial groups of the crowd, according to the determined crowd's reaction measurement parameters and scale and
a Crowd Management Module for determining or updating visual customized grouping of the crowd for each user, wherein for each user, at least partial group of users is selected and grouped from the plurality of users, based on predefined grouping rules and thus holds for each viewer in the event, a personalized display of the crowd.

According to some embodiments of the present the system is further comprising of:
Data-Push Plug-in Module for delivering change notifications, which come from the Crowd Management Module and the Crowd's Reaction Measurement Module, to the personal terminals of each user in the crowd,
Client Application Module, residing in the personal terminals of each user, for displaying the personalized crowd presentation which comprise of (1) the specific virtual crowd identities (avatars) of the customized groups which represent the specific viewers, (2) position and layout of the avatars and (3) graphical effects reflecting crowd personal and/or partial group reactions, according to the information and notifications which comes from the Data-Push Plug-in Module;

According to some embodiments of the present invention the personalized visualization of the crowd for each viewer which is based on the determined crowd presentation

According to some embodiments of the present invention the Crowd Management Module is further determining or updating visual customized grouping of the crowd for each user according to user's preferences and explicit requests.

According to some embodiments of the present invention the content item is a scheduled content event which takes place on specific time period and the received real time event data relates to specific scenarios occurring during the scheduled content event and relate to the scheduled content event.

According to some embodiments of the present invention the system further comprising of:
Event Data and Format Module for receiving predefined content format rules, receiving real time event data (external or internal), which includes data that is (1) received in real time, (2) said is related to the consumed content and (3) occurred during the time the content is consumed, checking the real time data against the format rules and sending change notifications in crowd presentation according to the predefined format rules and the received event data to the Data-Push Plug-in Module,

According to some embodiments of the present invention the real time analysis of the user interactions is further comprised of identifying user behavior pattern based on user's interaction analysis.

According to some embodiments of the present invention the Event Data and Format Module is further includes format rules of the content items, which relate to the viewers' individuals reactions and/or to the measured crowd's reaction level and further applies changes in content presentation objects, and/or in the content event scenario, according to viewers' individuals reactions and/or to the measured crowd's reaction level.

### BRIEF DESCRIPTION OF THE DRAWINGS

The present invention will be more readily understood from the detailed description of embodiments thereof made in conjunction with the accompanying drawings of which:

FIG. 1 is a flowchart illustrating the basic flow of a content event, accompanied by the system's virtual crowd visualization, according to some embodiments of the invention;

FIG. 2 is a block diagram, illustrating communication between the main value-chain components for managing events in which audience consumes digital content, according to some embodiments of the invention

FIG. 2A is a block diagram, illustrating communication between the main value-chain components for managing events in which audience consumes digital content, while the content format management is part of the invention's system, according to some embodiments of the invention.

FIG. 3 is a block diagram, illustrating the major software modules in an application server and the communication between them and the main value chain components, according to some embodiments of the invention;

FIGS. 4& 5 are a block diagrams, illustrating communication between several software modules in an application server, the CFM, the Client Application and Real Time Data Push Servers, according to some embodiments of the invention;

FIG. 6 is a flowchart diagram, illustrating a process of an event builder wizard, according to some embodiments of the invention;

FIG. 7 is a diagram, illustrating an example of a content page, according to some embodiments of the invention;

FIG. 8 is a flowchart illustrating a process of continuously measuring and empirically displaying the crowd activity, according to some embodiments of the invention;

FIG. 9 is a flowchart illustrating a process of managing a personalized subset view of the crowd's presentation for each viewer, according to predefined grouping policies of the system, according to some embodiments of the invention;

FIG. 10 is a flowchart illustrating a process of managing a personalized subset view of the crowd's presentation for each viewer, according to the viewer's requests, according to some embodiments of the invention;

FIG. 11 is an explanatory diagram, illustrating a display of a personalized crowd grouping, according to some embodiments of the invention; and

FIGS. 12, 12A, 12B and 12C are diagrams which illustrate the association between the method's and the system's main functionality and the system's modules, according to some embodiments of the invention.

### DETAILED DESCRIPTION

Before explaining at least one embodiment of the invention in details, it is to be understood that the invention is not limited in its application to the details of construction and the arrangement of the components set forth in the following description or illustrated in the drawings. The invention is applicable to other embodiments and/or may be practiced or carried out in various ways. Also, it is to be understood that the phraseology and terminology employed herein is for the purpose of description and should not be regarded as limiting.

The present invention, in some embodiments thereof, discloses a method and system for providing and managing a social platform of digital content consumers, in a public communication network, which implements the following major features: (1) Audience Visualization, (2) Audience Reaction Visualization, (3) Audience Reaction Measurement, and (4) Crowd/Audience Management.

The term “Audience Visualization” as used herein in this platform is defined as the ability to display digital content consumers as virtual crowd by letting each consumer to choose a virtual graphical identity (avatar) that will represent him while consuming the content. Upon choosing a digital content to consume, the consumer's avatar will be graphically placed among other avatars who are consuming the same digital content at the same time in that public communication network. By doing so, the method creates virtual visualized audience

The term “Audience Reaction Visualization” as used herein in this platform is defined as the option for each individual of the virtual audience to react to the content, expresses her or his thoughts and feelings, make visualized gestures and interact with the content and with other avatars, while all these reaction options are being visualized and displayed by the system to other viewers. In a non limiting example, actions that a viewer can perform are (i) making human gestures that are being visually reflected through the viewer's character that is presented in the crowd (like yawning, clapping, laughing etc. . . . ); (ii) sending targeted messages to other viewers (and/or to the performers in a video content); and (iii) answer poll questions and ranking the content. Moreover, in specified themes, the viewers' reactions may become an integral part of the content format and can affect its dynamics. Furthermore, in a video content event, the viewers may become performers by themselves.

The term “Audience Reaction Measurement” as used herein in this platform is defined as a way to measure the overall crowd reaction and to display it in an empiric manner. In “Audience Reaction Measurement”, the system provides measurement and display tools which can continuously reflect the overall crowd's involvement, attention, mood and opinion which may regard to the consumed content. The visualization of the audience and its reactions as well as the measurement of the overall activity aims to simulate a live show experience, where viewers may feel as if they are part of a live audience, grasping the atmosphere and energy of the event.

The term “Crowd Management”—as used herein in this platform is defined as various abilities and features that may be provided to the event moderator and to the individual viewer for displaying and managing the visualized crowd that is attending the same content event. The major purpose of the Crowd Management is to provide for each viewer a personalized crowd view according to the viewer's preferences and the moderator's general policies provided by the system. Meaning, the Crowd Management may let each viewer, prior and during an event, to determine, shape, modify and rearrange her or his crowd composition proactively. Crowd Management includes features such as: (i) detecting and displaying the viewer's friends in the crowd of viewers; (ii) allowing the user to browse different viewers groups in the crowd and to place herself or himself in different groups in the crowd; (iii) marking individuals in the crowd as the viewer's favorites; (iv) share and invite the viewer's social friends to the event; (v) grouping viewers with the same preferences to the same crowd section; and (vi) replacing inactive viewers with active ones to a certain level and vice versa.

The term “public communication network” as used herein in this platform is defined as any IP network that publishes digital content for users for consumption, such as the internet, intranet, Internet Protocol Television (IPTV), cable television (TV) networks etc.

The term “crowd presentation” as used herein in this platform is defined as the visual elements which the system and method implement for displaying the virtual crowd. The visual elements consist of (1) the specific virtual crowd identities (avatars) of that crowd display which represent specific viewers, (2) position and layout of the avatars and (3) graphical effects reflecting crowd personal and/or partial group reactions, according to viewers' individuals reactions and/or to the measured crowd's reaction level;

The terms “content” as used herein in this platform is defined as digital content that is consumed by the virtual audience. The digital content may be a live or recorded video broadcast event, audio broadcast and text content (articles, blogs etc. . . . ).

The term “content page” as used herein in this platform is defined as the digital page from which the content may be consumed by the viewers. The content page may contains one of the following: (i) the content itself; (ii) the virtual crowd; and (iii) other graphical elements and widgets which relate to the content. For example, a content page may be an HTML page with a video player in which the content is played, a virtual crowd component and other widgets such as users comments history, polls questions etc.

The term “content event” used herein in this platform is defined as a scheduled event in which a content item is being published and become available for consumption by users of a certain communication network

The present invention may utilize video digital content. Without limiting the invention and the general description herein, the content that this document would mostly refer to would be live and recorded video content.

The term “content format” as used herein in this platform, is defined as a bundle of particular set of rules that the content event may follow in order to create a clear event scenario, context and concept—as in reality TV formats, sport events and other games. The referred content format rules in this platform are those which may affect (1) the content event scenario and flow, and (2) the graphical components which assemble the content page layout. Examples of content format functionality may be: (i) in case a football match, if a goal was scored the scoreboard widget in the content page should be updated accordingly, (ii) if more than 50% of the virtual crowd voted against a contestant in a music competition, this contestant should be eliminated from the competition. etc. . . . .

The term “CFM” as used herein in this platform, is defined as a software component which is responsible for (i) storing and updating the content format rules, (ii) enforcing the content format rules on the content event flow, (iii) communicating specific scenarios, which occur during and in relation to the content event, to other sub-systems and (iv) receiving events from other sub-systems which relates to the content event flow and which may affect the content event flow and content page layout.

The described platform may include a CFM as part of its system and method, or alternatively, the platform may integrate with a third party CFM and content delivery network that will display the content and modify it with accordance to the content format rules and to the audience reaction that will be communicated to it by the invention's interfaces. In that sense the method will act as a separate component that (1) can be attached as an application add on to other content platforms which provide the content independently, such as web portals and content websites and mobile app, or (2) can be used a second-screen application that runs with no visual coupling with the consumed content, but still relates to the content which is displayed on another device (such as a mobile application which accompanies a TV broadcast).

Having the CFM included in or integrated with the system, turns the invention to be a platform for creating new/advanced content formats both for TV and internet shows. This can be achieved by letting the interaction of the virtual crowd to be included in the content format rules and thus influence the content flow and scenario.

The method and system are implemented via client/server architecture. The client may be any display device such as computer, TV device and/or a mobile device application.

According to some embodiments of the present invention, a social video platform which implements “Audience Visualization”, “Audience Reaction Visualization and Measurement” and “Crowd Management”, combines several software modules.

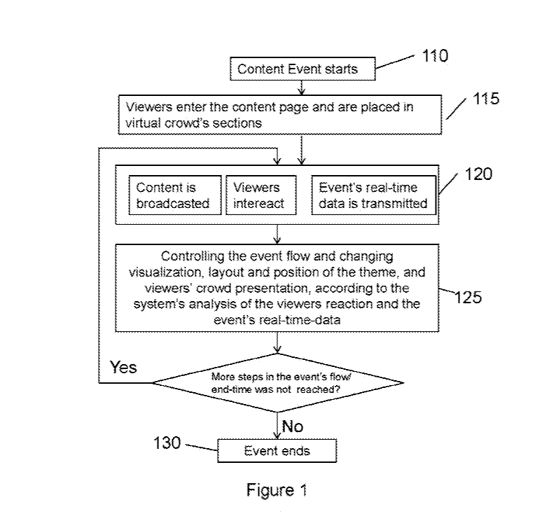

FIG. 1 is a flowchart illustrating the basic flow of a content event, accompanied by the system's virtual crowd visualization, according to some embodiments of the invention.

According to some embodiments of the invention, a content event main flow may be consisted of the following steps. A digital content event (of video, audio and/or text) may start and become available for consumption for a plurality of viewers (stage 110). Next, a user may enter the content event and log-in to the virtual crowd which accompanies the content event. The user may be placed in one of the crowd's sections together with other users who have been placed at the same section (stage 115) Next, in parallel to the content consumption, the viewers may interact with the content and between themselves, using their graphical identities. In addition, real-time data, which relates to the content, may be transmitted to the system during the content consumption (stage 120). As a result of the crowd's interaction and the real time event data, visualization, layout and position of the viewers' as well as the content page layout and content scenario may be controlled and changed (stage 125). In case it is not the last step in the event's flow and the event end-time has not been reached, going back to stage 120. In case the event scenario got to its last step or the event reached its end time, the event ends (stage 130).

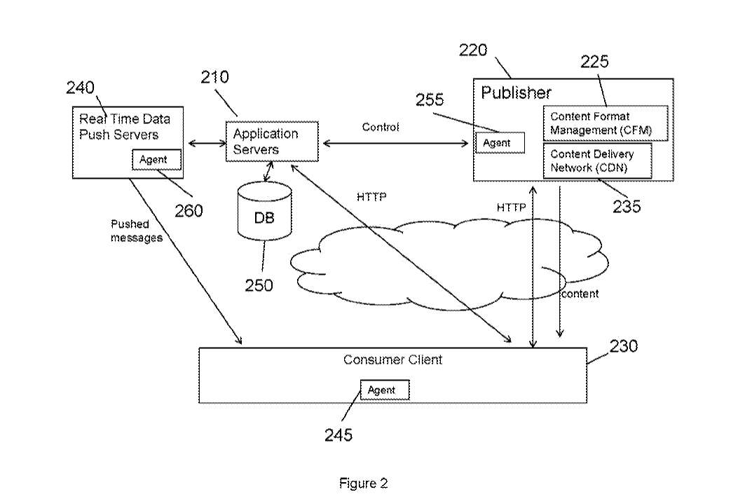

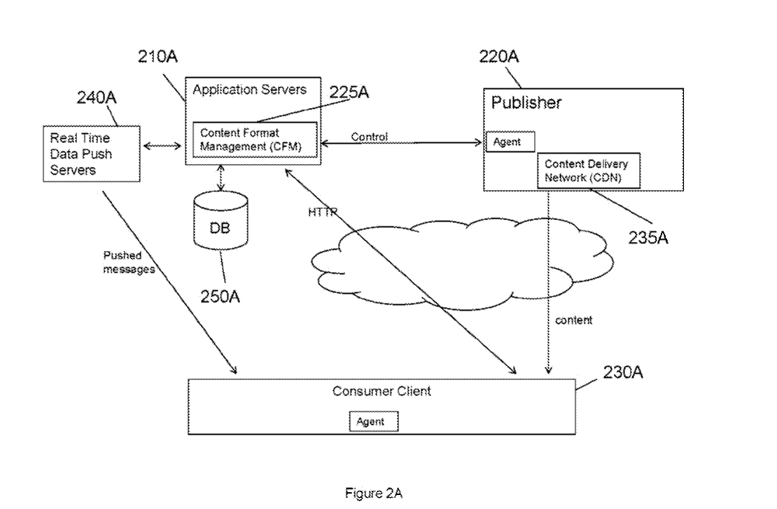

FIG. 2 is a block diagram, illustrating communication between the main value-chain components for managing events in which audience consumes digital content, according to some embodiments of the invention. FIG. 2 illustrates a general case where the digital content that is being consumed may be of any kind (text, audio, and video) and a Content Format Management (CFM) 225 is part of the Publisher's system and not part of the invention's Application Server 210.

According to some embodiments of the invention, a Consumer Client 230 receives content from the Content Publisher 220. The Content Publisher 220 may include a Content Delivery Network (CDN) 235 and a Content Format Management (CFM) 225.

The Publisher 220, may be any service which provides digital content for a plurality of users/viewers/subscribers. Publisher may be internet web content portals, IPTV and cable TV services etc. . . . .

The CDN 235 operates the technical method and mechanism for uploading, managing and delivering (streaming/broadcasting) the content. The CDN 235 system may reside within the Content Publisher component 220 as proprietary servers, or may be used as a cloud service, such as Akamai and Limelight.

CFM 225 may include, communicate and/or receive content format rules which may influence the content event flow and scenarios and content page presentation. The CFM 225 may be part of the Content Publisher component 220.

The Consumer Client 230 may be any computing device which may display the desired content and the visualized crowd, such as Personal computer (PC), television (TV), tablets, smartphones and other Android, iOS and Windows operating system and/or browser based devices.

According to some embodiments of the invention, the Application Servers 210 may handle the business logic of the system. The Application Servers 210 may manage: (i) the Audience Visualization; (ii) the Audience Reaction Visualization; (iii) Audience Reaction Measurement; and (iv) the Crowd Management. The Application Servers 210 may be a Java© server, .NET server or any other server-side software.

The Application Server 210 may store the business logic data in a database (DB) 250 for operational, persistency, scalability and analysis reasons. In a non limiting example, data that may be stored in the DB is: viewers' login details, viewer's devices, viewer's session duration, viewer's activities, reactions and comments throughout a period of content consumption etc. The DB 250 may be any standard relational DB such as Structured Query Language (SQL) server, MySQL, Oracle. Alternatively it may be a NoSQL based DB service in the cloud, such as Amazon's DynamoDB.

The Application Servers 210 may communicate the crowd activities to the CDN 235 and CFM 225 in case that the content format is designed to be affected by the crowd activity. Next, the CDN 235 and CFM 225 in the Publisher component 120 will transmit the content format changes to the consumer clients 230.

According to some embodiments of the present invention, application Servers 210, may register each of the consumers, who logged in as virtual crowd, to the Real-Time Data Push Servers 240. Then, it may transmit the relevant crowd activities and requests to the Real Time Data Push Servers 240, which will push the information related to the crowd activities and requests to the Consumer Clients 230 with accordance to the business logic of the application Servers 210.

The Real Time Data Push Servers 240 may be any push message service or server that is able to receive a message and send it to one or more of its registrants. The Real Time Data Push Servers 240 may be a standalone server such as comet server or a cloud service.

Since the Application Servers 210 communicates with: (i) the Publisher component 220; (ii) the Real Time Data Push Server 240; and (iii) the Consumer Client 230, some “agent” modules 260, 245 and 255 may optionally reside in those subsystems using the appropriate APIs and/or plug-ins in order to support the method's and system's logic.

FIG. 2A is a block diagram, illustrating a client-server architecture of main value-chain components that are building the overall solution, according to some embodiments of the invention. FIG. 2A illustrates a case in which the content is video and the content format management (CFM) 225A is part of the invention's system and method and not part of the Publisher system as illustrated in FIG. 2.

According to some embodiments of the invention, in addition to the description of the Application Servers 210 mentioned in FIG. 2, the application servers 210A may act as the CFM as described in section 0015, 0016 and 0026

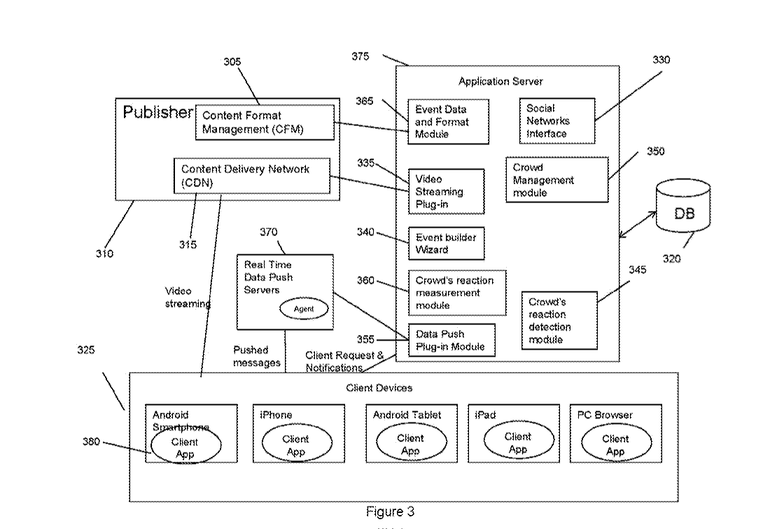

FIG. 3 is a block diagram, illustrating the major software modules in an application server 375 and the communication between them and the main value chain components, according to some embodiments of the invention.

According to some embodiments of the invention, implementation of the present invention is mainly in the application server 375 (210 as seen in FIG. 2) and on the Client Devices 325 (230 as seen in FIG. 2 and explained in section 0027).

The main functionality of the Crowd's Reaction Detection module 345 is to receive and process all comments, requests and reactions of the content event's virtual crowd viewers. The Crowd Reaction Detection Module 345 may perform the following functionality: (i) send relevant messages of the viewer's requests and committed reactions to the Event Data and Format Module 365 to check if the transmitted messages should modify the content event flow and content page according to the event's content format; (ii) send the relevant messages containing the viewer's requests and committed reactions to the Crowd Management Module 350 for managing and updating the relevant viewers that their personalized crowd view may be affected by these transmitted requests and reactions; (iii) send messages containing the relevant viewer's requests and committed reactions to the Crowd Reaction Measurement Module 470 to add these transmitted requests and reactions to the crowd's activity level calculation and measurement; and (iv) act as an overall crowd activity load balancer in cases where the overall crowd activity ratio is too high than what was set by the event owners (in this case it can use several algorithms to reduce the activity ratio such as accumulating similar actions to a single one, discarding some actions or delaying them etc.)

According to some embodiments of the invention, Crowd Management Module 350 may manage the presentation of the avatars' crowd composition for each user. By doing so, it may provide to each viewer in the event, a personalized display of the crowd and also may enable the viewer to shape, modify and rearrange her or his crowd composition proactively.

While the number of viewers is unlimited, the audience area in the screen of each viewer may be limited to a couple of hundreds avatars. In order to increase the level of engagement of the viewers, each viewer will be displayed with a personalized view of the audience avatars which will contain only a subset of the actual crowd who is consuming the content. For this purpose, the Crowd Management Module 350 may contain and continuously maintain, for each viewer, the list of individuals from the crowd who are currently included in his/her crowd composition/view.

The Crowd Management Module 350 is also responsible for updating each of the personalized-crowd-view in case one or more of the individuals in a certain crowd display have made a visual interaction such as making gestures or sending a text message). For this purpose, upon any activity of an individual in the crowd, the Crowd Management Module 350 may scan the personalized crowd composition lists and update the relevant crowd compositions according to the crowd's activity and the event scenario. It then may send to the Data Push Plug-in Module 355 the appropriate data that will be pushed to the relevant viewers which their crowd displays should be affected due to the detected activity. For example, if “user A” has made a cheering gesture, the Crowd Management Module 350 may scan all the viewers' personalized crowd-view compositions and allocate the viewers that user A is included in their crowd-view, and then may send to the Data Push Plug-in Module 355 a message that will be distributed to those users, saying that their client device should display a cheering gesture for user A.

The personalized crowd composition of each viewer may be influenced by (i) general policies and rules which are determined by the event owners and system features; and (ii) the viewer's own preferences and personal requests.

General Crowd Management policies that can be used by the system to automatically determine and updating the viewer's personalized crowd composition, may include (i) keeping a random portion of audience individuals who are placed together to consume the content; (ii) maintaining a certain level of viewers who are active (may replace non-active viewers); (iii) inserting a certain number of viewers who have the same fields of interest, attributes, properties and preferences as the viewer's; (iv) keeping a certain level of the viewer's Facebook™ and Twitter™ friends or any other social platform connections; and (v) increasing and decreasing the actual number of viewers that will be displayed in the crowd view. The personalized crowd view may include many other policies, filters and options.

The sub-section portions definitions which assemble the overall viewer's personalized crowd view may be determined by the system and/or the event moderator, and they also may be modified, before and during the event by the viewer. For example, a viewer may decide he would like to increase the allowed portion of his social network friends in his crowd view or decrease the portion of his preferences matched viewers. A user may also determine that his crowd view will consist of his social friends only (“private room”).

The system may strive to have a commutative placement of viewers in their personalized crowd views in order to increase the level of engagement. Meaning that if user A was placed in user B's crowd-view, the system will try to put userB in user A's crowd view as well. The system may graphically mark viewers who are not commutative in a user's crowd-view, so he will know they cannot see him, although he can see them.

Viewer's personal requests and preferences that can be used to shape, modify and rearrange her or his crowd composition may be: (i) to increase/decrease the amount of viewers who share the same certain fields of interest, attributes, properties and preferences; (ii) to replace the random portion of viewers in his/her current crowd composition with new different randomly selected avatars (moving to another audience “section”); (iii) to mark an individual in the crowd as “favorite”—so it will not be automatically replaced/removed from the viewer's crowd display; (iv) to remove from the crowd display avatars which were marked by the viewer as “non grata”; and (v) to replace inactive avatars with active ones and vice versa, according to the viewer's determined level.

Upon any viewer's request to change his crowd composition, or in case there are personalized crowd compositions which are not fit to the System's General Crowd Management policies, the Crowd Management Module 350 may change the relevant personalized crowd compositions according to the user's request and/or the General Crowd Management policies. It may then send to the Data Push Plug-in Module 355 the appropriate data that will be pushed to the relevant viewers which their crowd displays should be affected due to the changes that have been made.

This constant maintenance and updates may greatly contribute to the invention's scalability since it filters the activities that are coming from the crowd and marks only the viewers in the crowd that will be affected from the activity.

The Crowd Reaction Measurement Module 360 may get from the Crowd Reaction Detection Module 345 relevant messages containing information on users' interaction, grade each of the crowd's reaction and set it in a predefined formula that will reflect the crowd's involvement and “Energy”.

By receiving, grading and calculating the varied inputs from the crowd, such as: ratings, messages and variety of gestures, the energy and atmosphere level of the event may be reflected by the Crowd's Reaction Measurement Module 360 in an empiric manner and in real time or near real time.

According to some embodiments of the invention, the can be of any predefined formula that the event owner will decide upon. The calculation may take the following parameters as factors: (i) the time interval during which all actions and comments which were generated by the crowd are accumulated; (ii) all of the crowd's reaction that was generated during this time interval (such as text comments, ratings of all types, gestures etc.); (iii) a coefficient which weights each of the crowd's action (yawning, clapping, crying, throwing flowers etc.); (iv) a coefficient which grades the anticipated crowd involvement of this kind of event. For example, the coefficient of live rock concert will not be similar to the coefficient of a recorded political debate show; and (v) calculation results that were measured in the previous time intervals of this event.

This continuous measurement may be then sent to the Data Push Plug-in Module 355 to push the updated calculated values to the event's participants as an event “Energy Meter”, so, participants may actually know what the energy/attention/mood of the crowd is, at any given moment.

According to some embodiments of the invention, the Event Data and Format Module 365 may be responsible for modifying the event's scenario and content page presentation, according to the content format rules in conjunction with the reactions that come from the crowd. The Event Data and Format Module 365 may get from the Crowd's Reaction Detection Module 345 messages which contain information about the recently committed crowd reactions. It may then check the messages in conjunction with the content format rules it contains, and in case one or more of these format rules refers to the received message, the Event Data and Format Module 365 may do one of the followings: (i) in case the CFM 305 is part of the Publisher 310 system, it may send the relevant reactions to the CFM 305 by invoking a predefined API. The CFM 305 may then change the content event scenario and content page presentation, according to the content format rules. The API can be of any software, such as SOAP, JavaScript, push queue etc. (ii) in case that the CFM 305 is part of the Application Server 375 and not of the Publisher, the Event Data and Format Module 365 may act as the CFM itself, meaning, it may change the content event scenario and flow and/or the content page presentation independently.

According to some embodiments of the invention, the Event Data and Format Module 365 may also be responsible for getting from the CFM 305 data that relates to the content that is being broadcasted (real-time event data). Upon receiving a real-time event data, the Event Data and Format Module 365 may check this data against the event format rules to see if there are rules which refer to the received real-time event data. If so, the Event Data and Format Module 365 may send the relevant messages to the Data Push Plug-in Module 355, containing the information of how the crowd presentation should be affected.

Since the number of viewers can be unlimited and number of transmitted activity messages can reach very high numbers per event, the Real time Data Push Servers 370 should be a highly scalable subsystem. Therefore, the Real Time Data Push Servers 370 may be consisted from several proprietary push servers which act as a cluster or a cloud based service with a generic API.

According to some embodiments of the invention, the Data Push Plug-in module 355 may receive notifications which relates to the crowd presentation and grouping from the Crowd Management Module 350 and/or the Crowd Reaction Measurement Module 470 and/or the Event Data and Format Module 365 and then may invoke an API in Real Time Data Push Servers 370 to push these notifications and crowd presentation updates to all viewers or to the relevant portion of the crowd that these notifications and updates affect their crowd display.

A basic Real Time Push Message Servers 370 may get Hypertext Transfer Protocol (HTTP) messages and may push the HTTP messages to all of its registrant browsers. According to the present invention, the Real Time Data Push Servers 370 may contain a special “agent” module or expose an API in order to communicate with the Application Server 375 and to carry on its instructions and logic.

The application server 375 may be used as a focal point of the Real Time Data Push Servers 370 for all incoming messages. The module that interact with the Real Time Data Push Servers 370 in the application server may be the Data Push Plug-in module 355.

In case the Real Time Data Push Servers 370 would be a scalable and high availability cloud service, the main functionalities which may be required from the Data Push Plug-in Module 355 may be (i) to mediate between the API of the cloud push service and the business logic of the invention (including creating and defining viewers groups, such as room X, friends of viewer Y, all the viewers who are fans of a certain football team etc.), (ii) to invoke the Real Time Data Push Servers 370 API according to the business logic of the invention; and (iii) to act as a load balancer by regulating the ratings, gesturing and messages load, in order to prevent visual overload on the viewer's screens

In case the Real Time Data Push Servers 370 would be a proprietary push servers cluster, the additional functionalities which are required from the Data Push Plug-in Module 355 may be (i) to register and map each of the event's viewer to a single push server in the cluster while maintaining an approximate equal number of viewers per push server; (ii) to manage the number of push servers in a cluster to achieve high system availability and elastic scalability;

In advanced themes, the Data Push Plug-in Module 355 may also acknowledge message transmission to all registrants i.e. message transaction According to some embodiments of the invention, in case the application server contains the CFM of a video event (and not the publisher) and the video event scenario may be affected by the virtual crowd's reactions, it may be required to integrate with various live and online video enablers i.e. CDNs 315, as most of the publishers have their own existing CDN solutions. The Video Streaming Plug-in 335 role may be to reduce integration costs and effort when a new CDN 315 is introduced. The Video Streaming Plug-in 335 may mediate between the platform requirements from the CDN and the CDN's API. Accordingly, the solution obtains the ability to integrate with different video streaming subsystems without the need to change its core product code In some cases, there might be a missing functionality in the CDN 315 that cannot reside in the Video Streaming Plug-in 335. In order to achieve this functionality, it may be required to add a CDN Agent 385 that will carry out the missing business logic

Each content format may require new theme templates with proprietary customization requirements, both for the content page presentation and the event scenario, such as the number of video sources/players in the theme, the crowd's position, avatar's design, use widgets and many more. According to some embodiments of the invention, event builder wizard 340 may provide an API that will help in designing and customizing the content page presentation and manage the content format rules with no or minimum additional coding.

As a social platform, one of the major features of the invention is to let each of the viewers to watch the content with their social network friends who are also consuming the content. That is, each viewer should have the ability to see her or his social network friends in his personalized audience composition

The Social Network Interface 330 may connect to social networks such as Facebook™ and Twitter™ and for each viewer in the event may import his or her list of friends and then allocate from this list the friends who have also logged in to the virtual crowd to consume the same content as the viewer does. With this list ready, the Social Network Interface 330 may add send a message to the Crowd Management Module 350, to include the list of the viewer's friend in his personalized crowd view

The Social Network Interface 330 may also be used for letting the viewer to invite friends to the event and to post the event to other social platforms and networks

According to some embodiments of the invention, a Database (DB) 320 may be used to store relevant information in order to keep data persistency of the system during a content event. The DB 320 may store general information of the event, such as the event type, the widgets that are going to be used, the suggested gestures, the format rules etc. The DB 320 may also store real time information of an occurring event, such as the current personalized crowd compositions of each viewer, the current number of crowd sections, the current crowd's energy level etc. The system may use a DB interface layer and a caching layer to improve its performance and reduce the load on the DB 320 itself.

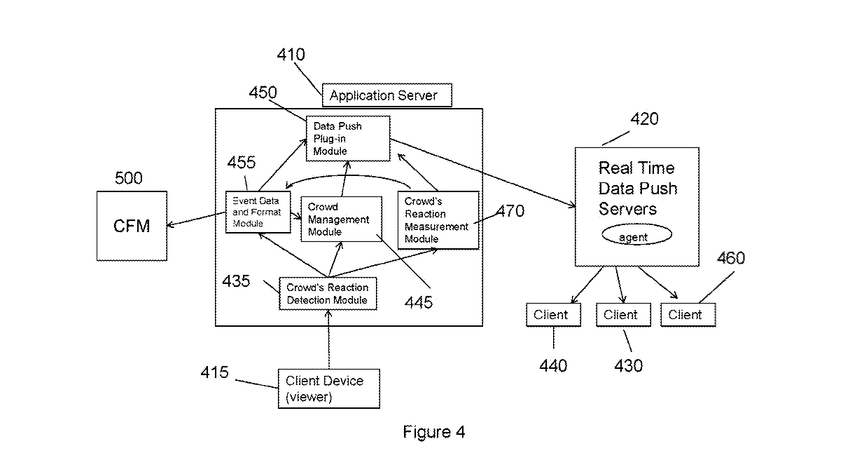

FIG. 4 is a block diagram, illustrating communication between several software modules in an application server 410, a Client Device and Real Time Data Push Servers 420, according to some embodiments of the invention. The described flow may be triggered upon a reaction that will be performed by one of the viewers.

According to some embodiments of the invention, a reaction that will be performed by a viewer (using Client Device 415) may be sent to the Application Server 410. In the Application Server 410, Crowd's Reaction Detection Module 435 may receive the reaction message from the client and do the followings: (i) according to the current reaction ratio and the limitations that were given by the event moderator on the desired interaction load, determine whether to process this reaction or to discard or accumulate the reaction in order to reduce the interaction load; (ii) in case the load limitations allow to process the reaction, send message with the reaction's metadata to the Event Data and Format Module 445 to check if the event flow and/or content page has to be modified, according to the content format's predefined set of rules that relate to the crowd's reaction input; (iii) send message with the reaction's metadata to the Crowd Management Module 450 for mapping and associating the committed reaction to the relevant viewers that their personalized crowd display contains the viewer who performed this reaction; and (iv) send message with the reaction's metadata to the Crowd Reaction Detection Module 470 to grade the reaction and add it to the crowd's energy level calculation.

The Crowd's Reaction Detection module 435 may send the reaction to Crowd Management Module 450. The Crowd Management module 450 may scan all of the viewers' crowd compositions and allocate the viewers which their crowd display includes the viewer who made the reaction.

Next, The Data Push Plug-in Module 455 may get from the Crowd Management Module 450 a message which contains the following details: (i) the viewer's identifier which identifies the viewer who performed the reaction; (ii) the reaction type that need to be distributed for display; and (iii) the list of viewers that the viewer who performed the reaction is included in their display. Next, the Data Push Plug-in Module 455 may translate the message to a valid API call of the Real Time Data Push Servers 420. Next, the Real Time Data Push Servers 420 may receive the message from the Data Push Plug-in Module 455 and may distribute the reaction to its specific registered clients that were specified in the message.

In Parallel, the Crowd's Reaction Detection Module 435 may send the reaction message to the Event Data and Format Module 445. The Event Data and Format Module 445, may receive the reaction message and with accordance to the event's content format rules it contains, it may determine whether the event scenario and/or the content page presentation should be changed as described in section 0054

For example, in a singing competition video event, a specific client may negatively rate the contestant who is currently performing, and according to the format rules, this negative rating should: (i) update the scoreboard widget which is part of the event's content page and also (ii) disqualify the singer and dismiss him from the show. The scenario change (disqualifying the contestant) will be triggered by the Event Data and Format Module 445 that will inform the CFM 500 about the disqualification. The content page presentation change (updating the scoreboard) will also be triggered by the Event Data and Format Module 445 by sending a message to the Data Push Plug-in Module 455 to display an updated scoreboard.

In Parallel, the Crowd's Reaction Detection Module 435 may send the reaction message to the Crowd's Reaction Measurement Module 470, with the committed action. The Crowd's Reaction Measurement Module 470 may then add this reaction to a certain pre-defined calculation (formulas) which reflects the crowd's reaction level. Then the result of the new measured reaction level which includes the new reaction will be sent by the Crowd's Reaction Measurement Module 470 which will invoke the relevant API call to the Data Push Plug-in Module 455, that in turn, will push the result to all relevant clients in order to display the new value of crowd's reaction level graphically.

Another possibility is that the Crowd's Reaction Measurement Module 470 may send the new calculated reaction level/value to the Event Data and Format Module 445, which in turn will check if this new level may trigger a change in the event's scenario or content page presentation. For example, if in one of the content format rules, which are included in the Event Data and Format Module 445, says that if the Energy level of the crowd is getting to 100—the crowd should perform a Mexican wave gesture.

According to some embodiments of the invention, each client 460, 430 and 440 has a designated application agent which may get the message from the Real Time Data Push Servers 420, allocate the avatar in the crowd display which made the reaction, and may execute the reaction on that avatar (e.g. yawning, clapping etc.)

FIG. 5 is a block diagram, illustrating communication between several software modules in an Application Server 510, CFM 500 and Real Time Data Push Servers 520, according to some embodiments of the invention. The described flow may be triggered upon receiving a message from the CFM 500 containing real-time event data which related to the content format rules

According to some embodiments of the invention, the CFM 500 may trigger and send to the Event Data and Format Module 555 an event data that occurred during the content consumption and may influence the content page and particularly the crowd presentation. The Event Data and Format Module 555 may have a predefined API which the CFM 500 may invoke in order to communicate these events

The Event Data and Format Module 555 may get the event data and check it against the content format rules it contains. In case that the Event Data and Format Module finds that the received event data is included in the content format rules, it may send a message with the required crowd presentation and/or scenario change to the Data Push Plug-in Module 550 to distribute the change to all relevant clients.

For example, in a football match broadcast, in case a goal was scored, the CFM may send this message (“goal, team A”) to the Event Data and Format Module 555, which in turn scans its content format rules and finds that there is a rule which says that a “goal” should trigger a Mexican Wave gesture. Event Data and Format Module 555 may then send a message to the Data Push Plug-in module 550, which will push a message to the Real Time Data Push Servers 520, which will push a message to all the relevant clients to perform a Mexican Wave gesture to all the avatars which are categorized as Group A fans.

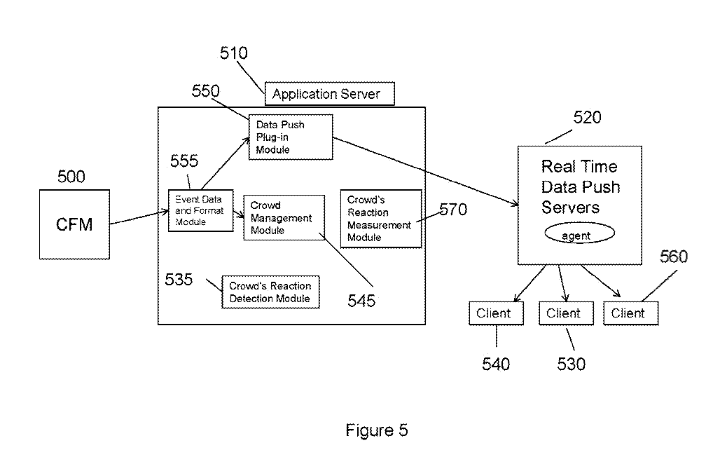

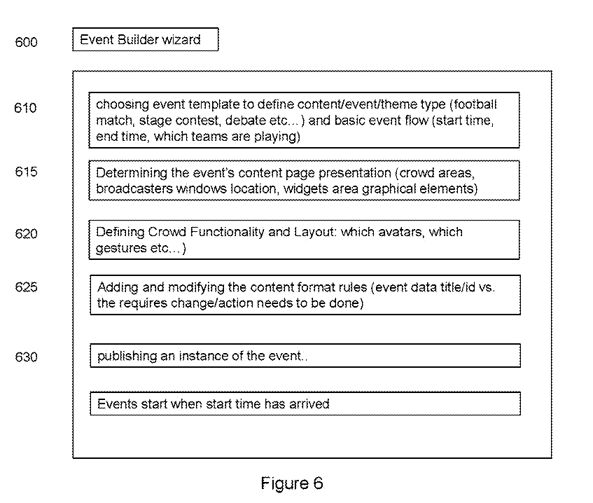

FIG. 6 is a flowchart diagram, illustrating a process of building a theme layout and scenario, by using an event builder wizard software component, to some embodiments of the invention.

According to some embodiments of the invention, a user may choose an event template to define basic event flow. For example, football match, stage contest with multiple broadcasting windows, debate etc. Then a more detailed properties may be defined such as the names and logos of the two teams in a football match, the name of the contestants in a debate session etc. . . . (stage 610). Next, the user may determine and set the content page presentation and layout which will host the content event. For example, location of the crowd area, video player, widgets and other graphical elements (stage 615). Next, the user may define the crowd and related widget functionality. For example, which avatar designs will be used, which gestures will be allowed and displayed, which widgets will be used etc. . . . ) (stage 620) Next, the user may add and/or modify the specific content format rules and flow properties that may influence the crowd presentation and theme layout and associate them to actual actions and manipulation. For Example (“max_negative_energy_meter”->“mega boo”, “goal”->“Mexican Wave”) (stage 625). Next, the user may publish an instance of the event that will then be ready to be launched when start time is reached (stage 630)

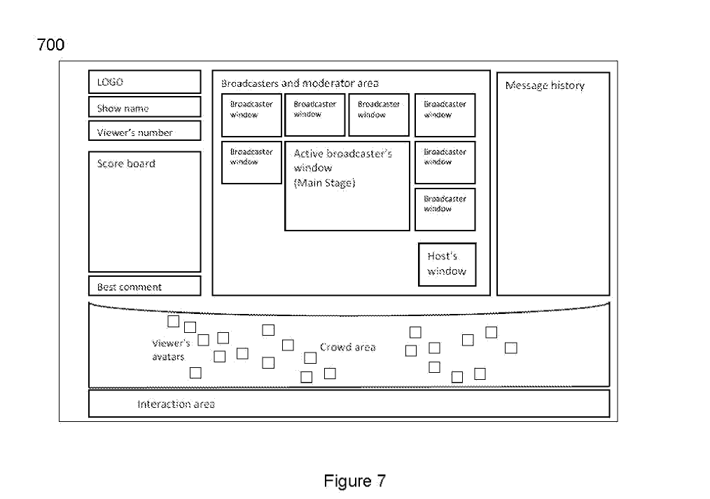

FIG. 7 is a diagram, illustrating an example of a content page, according to some embodiments of the invention.

In a non limiting example, the displayed content page 700 may be used for a stage art contest in which the contestants are being broadcasted in different locations. The event may be a singing, stand-up, debate, dancing or any other stage art contest, where each of the participants receives a limited time on the main stage. In this non limiting example, the content page may include virtual crowd component representing and visualizing the viewers of that content event. The viewers may express their emotions and feelings using some interaction options which implicitly and explicitly may rate the contestants' performance and determine the winner.

This content page example 700 contains several broadcasting windows and an “Active broadcaster's window” which is larger and acts as a main stage. A special window is allocated for the event's host that can interview the other performers. Other graphical components which are included in the layout are the scoreboard, best comment, message history etc.

The event's owner can decide and then customize the event layout and rules. For example, if more than 50% of the crowd have made a “boo” gesture during a performer's act. The performer will be eliminated from the show and his window will be removed from the layout.

The same event may have different layouts when being presented on a different client device and/or browser.

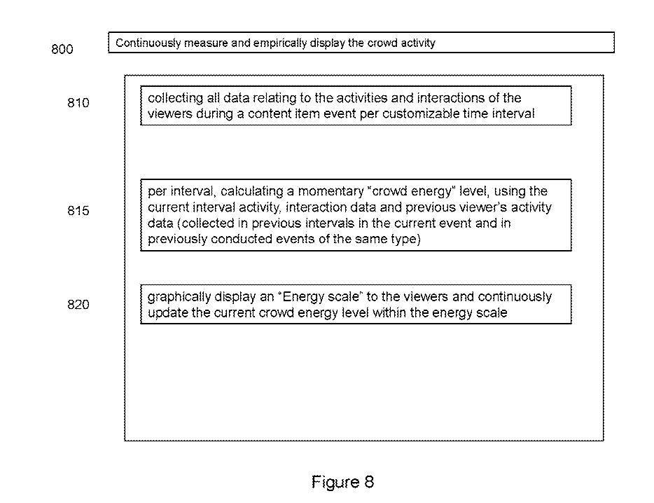

FIG. 8 is a flowchart illustrating a process of continuously measuring and empirically displaying the crowd's activity, according to some embodiments of the invention.

According to some embodiments of the invention, the process may begin by collecting all or partial data relating to the activities and interactions of the viewers during the show per customizable time interval (stage 810). Next, per interval, calculating a momentary “crowd energy” level by the Crowd's Reaction Measurement Module (as seen in FIG. 3), using the current interval activity data, previous viewer's activity data that was collected in the current event and in previously conducted events of the same type (stage 815). Upon the calculation of the “crowd energy” level in stage 815, graphically display an “Energy scale” to the viewers and continuously update the current crowd energy level within the energy scale (stage 820).

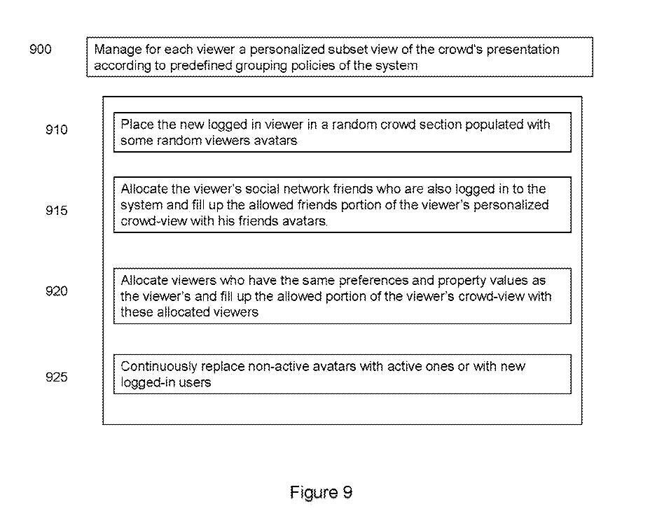

FIG. 9 is a flowchart illustrating a process of managing and maintaining a personalized crowd-view of a specific viewer by following some of the system crowd-composition policies, according to some embodiments of the invention.

Crowd Management Module 350 in FIGS. 3 and 445 in FIG. 4 may manage the personalized subset view of the crowd's presentation for each viewer by taking the following steps.

According to some embodiments of the invention, the system divides the total number of viewers in the virtual crowd to sections, since it is impossible to display a large number of audience avatars in one screen. The process may begin by placing the viewer, after performing log-in to the system, in a random crowd section, populated with some random viewers (stage 910). Next, the system may allocate the viewer's social network friends who are also logged in to the system and fill up the allowed friends' portion of the viewer's personalized crowd-view with his friends' avatars. For example, the system may have a default policy of allocating a portion of 10% of the crowd-view to the viewer's friends and in case each crowd section is set to 60 “seats”, then 6 seats may be reserved to the viewer's social-network friends (stage 915). Next, the system may allocate viewers who have the same preferences and personal property values as the viewer's, and fill up the defined portion of the viewer's personalized-crowd-view with these allocated viewers. For example, the system may have a default policy of allocating a portion of 20% of the viewer's personalized crowd-view to logged-in users that their preferences and other personal properties fully and/or partially match the viewer's preferences and personal property values. In case each crowd section is set to 60 “seats” and the viewer's age property is “20 years old” and a team fan property is “team A”, then 12 seats may be reserved to viewers who are at the same age range and their profile includes a notation that they are fans of team A. (stage 920). Next, continuously replace non-active avatars with active ones in the viewer's personalized crowd view, until reaching the defined portion limit of active viewers allowed to be displayed in the viewers' screen (stage 925).

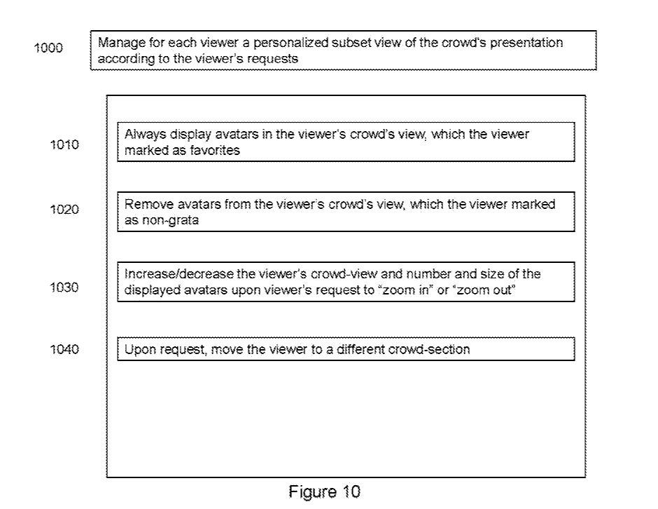

FIG. 10 is a flowchart illustrating a process of managing and updating a personalized crowd-view of a specific viewer following his explicit crowd-management requests, according to some embodiments of the invention.

The system allows a viewer to mark a viewer in his crowd view as “favorite”. Upon this action, the system may “lock” the marked viewer in the viewer's personalized crowd view and will not automatically replace him, as part of the continuous crowd-view update and maintenance of the system (stage 1010). Alternatively, a user may mark a viewer in his crowd view as “non grata” and the system may then immediately remove that viewer from his crowd view (stage 1020). Next, the system may create a larger view of the crowd, while increasing the avatars' image size, upon viewer's request to “zoom in”, or creating a smaller view of the crowd, while decreasing the avatars' image sizes, upon viewer's request to “zoom out” (stage 1030). Upon viewer's request to browse the crowd's sections and people, the system may place the viewer's avatar in a new section in the crowd (stage 1040).

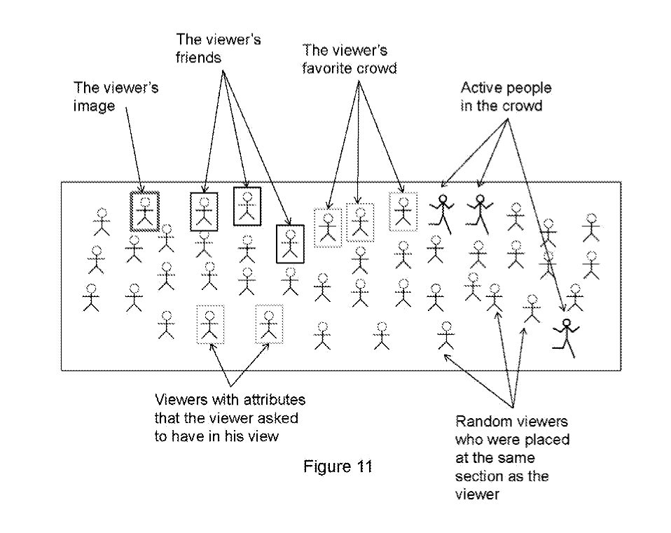

FIG. 11 is an explanatory diagram, illustrating a personalized crowd-view of a specific viewer, according to some embodiments of the invention.

In the diagram, the personalized crowd composition of a certain viewer may consist of the following avatar groups: (i) the viewer's image; (ii) the viewer's friends; (iii) the viewer's favorite crowd; (iv) active viewers that the system replaced with non-active viewers and (v) viewers with a set of attributes that the viewer asked to have in his crowd view.

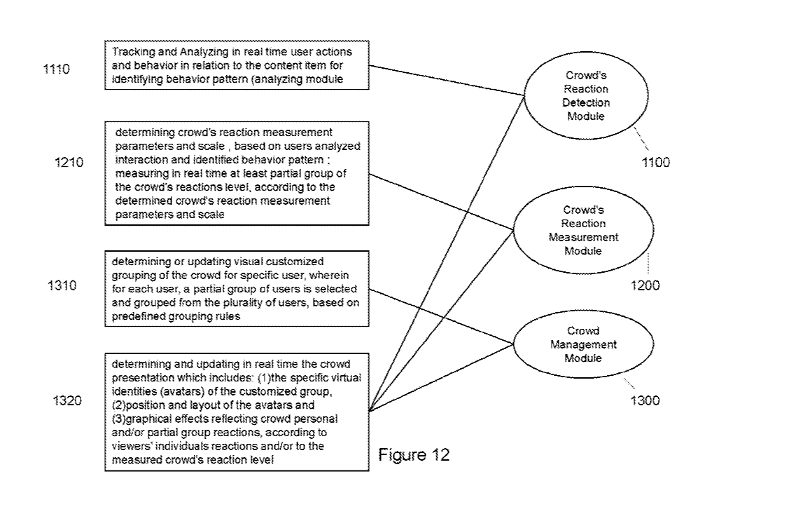

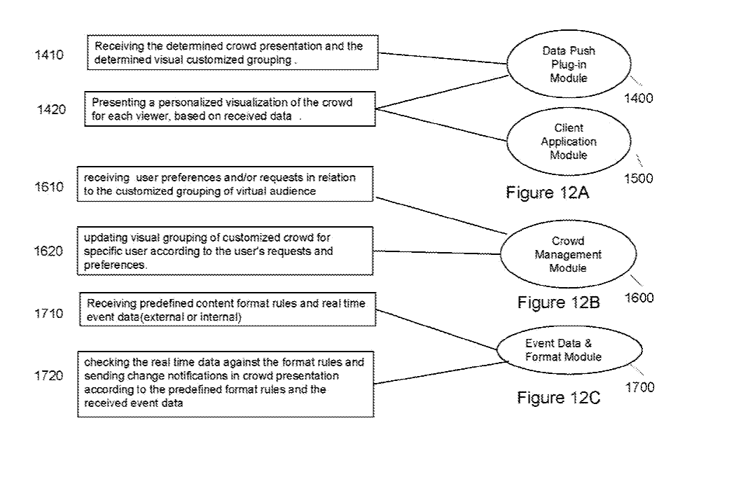

FIGS. 12, 12A, 12B and 12C are diagrams illustrating the association between the method's and the system's main functionality and some of the system's modules. The diagram 12 also describes the process of determining crowd presentation in a content event based on users' action and behavior, and the system's predefined grouping rules, according to some embodiments of the invention.

The first step of the process (1210), which is performed by the Crowd's Reaction Detection (1100) Module is tracking and analyzing in real time user actions and behavior in relation to the consumed content item;

The next steps, which is performed by the Crowd's Reaction Measurement Module (1200), are (i) determining crowd's reaction measurement parameters and scale, based on users analyzed interaction and identified behavior (1210); and (ii) measuring in real time at least partial group of the crowd's reactions level, according to the determined crowd's reaction measurement parameters and scale (1220).

In parallel, the Crowd Management Module (1300) performs the step of determining or updating visual customized grouping of the crowd for specific user, wherein for each user, a partial group of users is selected and grouped from the plurality of users, based on predefined grouping rules (1310);

Based on the viewers' individuals reactions and/or to the measured crowd's reaction level, the crowd Management Module (1300) determines and updates, in real time, the crowd presentation (1320), which includes: (1) the specific virtual identities of the customized grouping, (2) position and layout of the viewers' graphic virtual identities and (3) graphical effects reflecting crowd personal and/or partial group reactions, according to.

FIG. 12A is a diagram further illustrating the process of presenting each user a personalized crowd presentation, according to some embodiments of the invention. According to this process, the Data Push Plug-in Module (1400) receives from other modules the determined crowd presentation (1410) and the determined visual customized grouping for each viewer, and accordingly push these updates to the Client Application Modules (1500) in the viewers clients, which in turn present for each viewer a personalized visualization of the crowd (1420). These steps can be performed in parallel or in sequence.

FIG. 12B is diagram illustrating the updating of the customized crowd's visual grouping for each user, according to that viewer's requests, according to some embodiments of the present invention. According to this process the Crowd Management Module (1600), receives the user's preferences and/or requests in relation to the customized grouping of virtual audience (1610) and updates the visual grouping of customized crowd for specific user according to the received requests and preferences (1620).

FIG. 12C is a diagram illustrates a process of determining change notifications in crowd presentation based on received events, according to some embodiments of the invention. According to this process the Event Data & Format Module (1700), receives predefined content format rules and real time event data (from external or internal data sources) and checks the real time data against the format rules (1710) for determining and sending change notifications in crowd presentation according to the predefined format rules and the received event data (1720).

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described. Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method of visualizing and managing virtual audience over a data communication network, wherein virtual audience reflects and represents real human individuals while they are consuming and interacting with each other and/or with the same digital content item at the same time. the method comprising the steps of:
tracking and analyzing in real time or near real-time user interactions and behavior in relation to the consumed content item;
determining dynamic crowd's reaction parameters and scale, based on users analyzed interaction and identified behavior;
measuring and/or calculating in real time or near real-time at least partial group of the crowd's reactions level, according to the determined crowd's reaction measurement parameters and scale
determining or updating visual customized grouping of the crowd for specific user, wherein for each user, at least a partial group of users is selected and grouped from the plurality of users, based on predefined grouping rules; and
determining and updating for each user, in real time or near real time, the crowd presentation which includes: (1) the specific virtual crowd identities (avatars) of the customized groups which represent specific viewers, (2) position and layout of the avatars and (3) graphical effects reflecting crowd personal and/or partial group reactions, according to viewers' individuals reactions and/or to the measured crowd's reaction level;

2. The method of claim 1 further comprising the step of:
presenting a personalized visualization of the crowd for each user, based on the determined crowd presentation, and the determined visual customized grouping.

3. The method of claim 1 further comprising the steps of:
receiving real time event data which includes data that is (1) received in real-time/near real-time, (2) related to the consumed content and (3) occurred during the time the content is consumed;
checking received real time event data against predefined content item format rules, which include flow scenarios and guidelines that the content item and/or event shall follow; wherein the real time process of determining the crowd presentation is further based on the received real time event data in relations to the predefined content format rules;

4. The method of claim 1 further comprising the steps of:
receiving users' preferences and/or requests in relation to the customized grouping of virtual audience;
wherein the process of determining or updating the customized visual grouping of the crowd for specific user is further based on the user's requests and preferences.

5. The method of claim 4 wherein the crowd presentation is further based on the viewer's explicit requests and preferences which relates to the customized grouping of the virtual audience.

6. The method of claim 3 wherein the content item is a scheduled content event which takes place on specific time period and the received real time event data relates to specific scenarios which occur during and relate to the scheduled content event.

7. The method of claim 1 further comprising the step of
displaying in real time visualization or representation of crowd's measured and/or calculated reaction level, in relation to the crowd's reaction measurements parameters and scale.

8. The method of claim 1 further comprising the step of
analyzing in real time user interactions and identifying user behavior patterns based on user's interaction analysis.

9. The method of claim 1 further comprising the steps of
including format rules of the content items, which relate to viewers' individuals reactions and/or to the measured crowd's reaction level
applying changes in (i) the content event scenario; and/or (ii) the presented data, layout and graphics of the digital page in which the content is available for consumption, according to viewers' individuals reactions and/or to the measured crowd's reaction level, in relation to the format rules.

10. The method of claim 1 further comprising the step of applying changes in the presented data, layout and graphics of the digital page, which includes or relates to the content item, according to viewers' individuals reactions and/or to the measured crowd's reaction level.

11. A system of visualizing and managing virtual audience over a data communication network, wherein virtual audience reflects and represents real human individuals while they are consuming and interacting with each other and/or with the same digital content item at the same time, the system comprised of:
Crowd's Reaction Detection Module for tracking and analyzing in real time user interactions and behavior in relation to the consumed content item and identifying user behavior pattern based on user's interaction analysis;
Crowd's Reaction Measurement Module for (1) determining crowd's reaction measurement parameters and scale, based on users analyzed interaction and identified behavior, and (2) measuring in real time the reaction level of the overall crowd and/or partial groups of the crowd, according to the determined crowd's reaction measurement parameters and scale; and
Crowd Management Module for determining or updating visual customized grouping of the crowd for each user, wherein for each user, at least partial group of users is selected and grouped from the plurality of users, based on predefined grouping rules and thus holds for each viewer in the event, a personalized display of the crowd.

12. The system of claim 11, wherein presenting a personalized visualization of the crowd for each viewer, based on the determined crowd presentation, and the determined visual customized grouping, is further comprising of:
Data-Push Plug-in Module for delivering change notifications, which come from the Crowd Management Module and the Crowd's Reaction Measurement Module, to the personal terminals of each user in the crowd,
Client Application Module, residing in the personal terminals of each user, for displaying the personalized crowd presentation which comprise of (1) the specific virtual crowd identities (avatars) of the customized groups which represent the specific viewers, (2) position and layout of the avatars and (3) graphical effects reflecting crowd personal and/or partial group reactions, according to the information and notifications which comes from the Data-Push Plug-in Module.

13. The system of claim 11 wherein the Crowd Management Module is further determining or updating visual customized grouping of the crowd for each user according to user's preferences and explicit requests.

14. The system of claim 11 wherein the content item is a scheduled content event which takes place on specific time period and the received real time event data relates to specific scenarios occurring during the scheduled content event and relate to the scheduled content event.

15. The system of claim 11 further comprising of
Event Data and Format Module for receiving predefined content format rules, receiving real time event data (external or internal), which includes data that is (1) received in real time, (2) related to the consumed content and (3) occurred during the time the content is consumed, checking the real time data against the format rules and sending change notifications in crowd presentation according to the predefined format rules and the received event data to the Data-Push Plug-in Module.

16. The system of claim 11 wherein the real time analysis of the user interactions is further comprised of identifying user behavior pattern based on user's interaction analysis.

17. The system of claim 15 wherein the Event Data and Format Module is further includes format rules of the content items, which relate to the viewers' individuals reactions and/or to the measured crowd's reaction level and further applies changes in content presentation's design, layout and hosting page objects, and/or in the content event scenario, according to viewers' individuals reactions and/or to the measured crowd's reaction level.

18. The system of claim 11 wherein the Event Data and Format Module is further applying changes in the presented data, layout and graphics of the digital page, which includes or relates to the content item, according to viewers' individuals reactions and/or to the measured crowd's reaction level.
